(19) United States
(12) Patent Application Publication
(10) Pub. No.: US 2025/0254413 A1
(43) Pub. Date: Aug. 7, 2025

(54) SYSTEM AND METHOD FOR HYBRID AUTO EXPOSURE IMAGING CORRECTIONS

(71) Applicant: Dell Products, LP, Round Rock, TX (US)

(72) Inventors: Karthikeyan Krishnakumar, Austin, TX (US); Chih Hao Kao, Singapore (SG); Chien-Chih Liao, Taipei City (TW)

(73) Assignee: Dell Products, LP, Round Rock, TX (US)

(21) Appl. No.: 18/430,430

(22) Filed: Feb. 1, 2024

(51) Int. Cl. H04N 23/611; G06T 7/246; H04N 23/71; H04N 23/73

(52) U.S. Cl. CPC H04N 23/611; G06T 7/246; H04N 23/71; H04N 23/73; G06T 2207/30201

(57) ABSTRACT

A webcam includes a hardware microcontroller and a memory device. The hardware microcontroller executes program code of a hybrid face detection auto exposure module to detect a user's face within an image captured by the webcam and define a first image region of interest of the image that includes the user's face with the second image region of interest of the image including a background of the image, executes program code of a lighting detection module to detect brightness levels of the user's face within the first image region of interest and brightness levels in the second image region of interest, and executes program code of a hybrid face detection auto exposure module to determine if a background brightness change threshold level is exceeded and to automatically adjust an exposure setting for the first image region of interest of the image captured by the webcam when the threshold is exceeded.

### FIELD OF THE DISCLOSURE

The present disclosure generally relates to automatic exposure corrections for captured images. The present disclosure more specifically relates to automatic exposure of captured images based on facial detection in images for a web camera system.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more applications such as a gaming application. Further, the information handling system may include a webcam or other imaging device that captures images of the user during, for example, a videoconferencing session.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system including a webcam executing code instructions of a hybrid face detection auto exposure system according to an embodiment of the present disclosure;

FIG. 2 is a block diagram illustrating an information handling system including one or more of an external webcam or a built-in webcam executing code instructions of a hybrid face detection auto exposure system according to another embodiment of the present disclosure;

FIG. 3 is a graphic diagram of an image captured by a webcam including a first image region of interest and a second image region of interest used during executing code instructions of a hybrid face detection auto exposure system to determine when a face detection auto exposure module and lighting detection module adjust the exposure of the captured image according to another embodiment of the present disclosure; and

FIG. 4 is a flow chart showing a method of executing code instructions of a hybrid face detection auto exposure system for correcting exposure of an image captured by a webcam according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

An information handling system may include or be operatively coupled to a webcam. The webcam may allow the information handling system to capture images or videos of a user as the user, for example, engages in videoconferencing sessions. A webcam may include a digital signal processor or other microcontroller to execute executable code instructions of software or firmware that can control the shading or brightness levels of output of images and video captured in order to render clear and viewable images and video feeds. The webcam may include auto exposure (AE) software/firmware that automatically sets the exposure for each image or for the video such that those images are clear by selecting the appropriate shutter aperture settings and International Standards for Sensitivity (ISO) light sensitivity settings. However, during execution of this AE software/firmware, the user may detect that the image is occasionally overexposed or underexposed due to the AE software/firmware engaging a mean weightage AE algorithm across the entire image. While this may adjust the brightness of the image, issues may arise where the background of the user is very dark, the user's face may be overexposed resulting in a whiteout effect of the user's face. The opposite is also a problem using a mean weightage AE algorithm where the user's face is often darkened when the background is illuminated by a bright light source such as a window.

To correct this issue of over- or underexposure, the digital signal processor or other microprocessor of the webcam system may also execute code instructions of a face detection auto exposure system to utilize artificial intelligence to analyze or determine a face location and adjust exposure of the face in the image to prevent over- or underexposure of a face in the image. In some cases, execution of the artificial intelligence algorithm for the standard face detection auto exposure system assumes that the user's face and body is generally always at a central location within the viewable range of the webcam. Because users may not always present themselves directly within the middle of this viewable range, the execution of the AE algorithm may cause the face detection auto exposure system to hunt for a face for exposure adjustment as described herein. Further, the face detection auto exposure system hunting changes the brightness of the images and video at the webcam as the user changes position within the viewable range of the webcam. These changes of exposure may be slower due to the hunting and may be unnecessary since the exposure response should not be triggered by the changes in the image. For example, where a certain exposure setting is selected by the AE software/firmware and the face detection auto exposure system and the user introduces a darker object into the viewable range of interest for a face in the webcam image, such as putting a dark colored hat on the user's head, the brightness of the image may noticeably increase and then settle into a new brightness level over time. Similarly, if the user changes head position, such as to look down temporarily, the artificial intelligence face detection hunting of the face detection auto exposure system may adjust exposure of the system since the top of a person's head may be darker than an image of their face. In some drastic examples, this change in brightness may, even temporarily, under expose or even overexpose the image of the user's face and take time to readjust or not readjust at all from the artificial intelligence face detection hunting. These issues often lead to user dissatisfaction and frustration especially during a videoconference session where face-to-face conversations enhance the conversation.

The present specification describes a webcam having a digital signal processor or other microcontroller that executes a hybrid face detection auto exposure algorithm that both focuses on the user's face to set exposure levels (e.g., to set the ISO sensitivity settings) at a limited, detected face region of interest but also considers the illumination levels of the background in a second region of interest. In an embodiment, the webcam includes a hardware microcontroller, such as a digital signal processor, a memory device, and a power management unit (PMU) to provide power to the hardware microcontroller and memory device. The hardware microcontroller may execute computer-readable program code of the hybrid face detection auto exposure module to detect a user's face within an image captured by the webcam and define a first image region of interest in the image that includes the limited region around a user's face and a second image region of interest of the image that includes a background of the image captured by the webcam. This first image region of interest of the image may be shifted based on the detected location of the user's face in an embodiment.

The hardware microcontroller may also execute computer-readable program code of a lighting detection module to detect brightness levels of the user's face within the first image region of interest of the image and brightness levels in the second image region of interest of the image captured by the webcam. With this data, changes in the brightness levels within both of the first image region of interest of the image and the second image region of interest of the image may cause the hardware microcontroller to execute the computer-readable program code of the hybrid face detection auto exposure module to adjust exposure settings such as the ISO sensitivity settings of the webcam to automatically adjust the exposure levels of the image captured by the webcam or to avoid changes to the exposure settings such as the ISO sensitivity settings when changes in both the first image region of interest as well as the second image regions of interest are not detected. This hybrid auto exposure method, therefore, considers both the user's face as well as ambient background light within the viewable range of the webcam in order to maintain a certain exposure level within the first image region of interest of the image where the user's face is detected when the second image region of interest does not have a substantial change in the amount of light above a threshold amount of change.

In an embodiment, where no face is detected within the first image region of interest of the image, the hardware microcontroller may execute computer-readable program code of an auto exposure module to automatically adjust the exposure settings such as the ISO sensitivity settings or shutter aperture settings of the webcam across the whole image captured by the webcam. Because the user is not present, normal AE algorithms may be executed that applies appropriate exposure settings such as the ISO sensitivity settings or shutter aperture settings to capture the images at the webcam.

In an embodiment, the hardware microcontroller to execute the computer-readable program code of the hybrid face detection auto exposure module to set a brightness change threshold at the second region of interest in the image background that, when exceeded, adjusts the exposure settings such as the ISO sensitivity settings of the webcam to automatically adjust the exposure levels of the image captured by the webcam with respect to the first image region of interest for the face using the face detection as well as any exposure adjustments necessary for the second image region of interest for the background so that the whole image is adjusted. This brightness change threshold may be set as a change in brightness of 15% within the second image region of interest of the image in an example embodiment. If the change in brightness of the second image region of interest does not reach a threshold level of change (e.g., 15% or another threshold value), no image exposure adjustment is conducted on the first image region of interest or the second region of interest even if the first image region of interest has shifted dramatically such as by a user introducing a dark or light item such as a hat or turned her head such that less face is exposed. In this way, execution of code instructions of the hybrid face detection auto exposure module may avoid dramatic exposure adjustments and face detection hunting when a change occurs in the first image region of interest but a threshold of brightness change has not been detected at the second image region of interest in embodiments herein. This may avoid the problem of unnecessary exposure adjustments that are not due to background lighting being too bright or too low or a user's face being consistently, incorrectly exposed relative to the background lighting at the first image region of interest in the capture images in embodiments herein.

In an embodiment, where the brightness level within the second image region of interest of the image changes above a threshold level and the first image region of interest of the image changes such as due to the background changing significantly, the hardware microcontroller executes the computer-readable program code of the hybrid face detection auto exposure module to adjust the exposure settings such as the ISO sensitivity settings or shutter aperture settings of the webcam. Additionally, wherein where the brightness level within the first image region of interest of the image changes but the brightness level within the second image region of interest of the image does not change, the hardware microcontroller executes the computer-readable program code of the hybrid face detection auto exposure module to keep the exposure settings such as the ISO sensitivity settings of the webcam since it is determined that a temporary or unnecessary change has occurred and the exposure of the first image region of interest of the user's face need not be adjusted. Thus, operation of the systems and methods described herein requires both conditions to be met before the execution of the computer-readable program code of the face detection auto exposure module changes the exposure settings such as the ISO sensitivity settings or even shutter aperture settings in order to change the exposure values within the first and second image region of interests of the image captured by the webcam. In this way, unnecessary and annoying changes to the exposure to the user's face by face detection and auto exposure algorithms of previous systems may be avoided or eliminated.

Further, in some embodiments, the hardware microcontroller may execute computer-readable program code of the hybrid face detection auto exposure module to track the user's face and readjust the location of the first image region of interest of the image that includes the user's face as the user's face changes position. This allows the webcam to appropriately adjust the exposure levels within the first image region of interest and second image region of interest of the images captured by the webcam regardless of the detected location of the user's face.

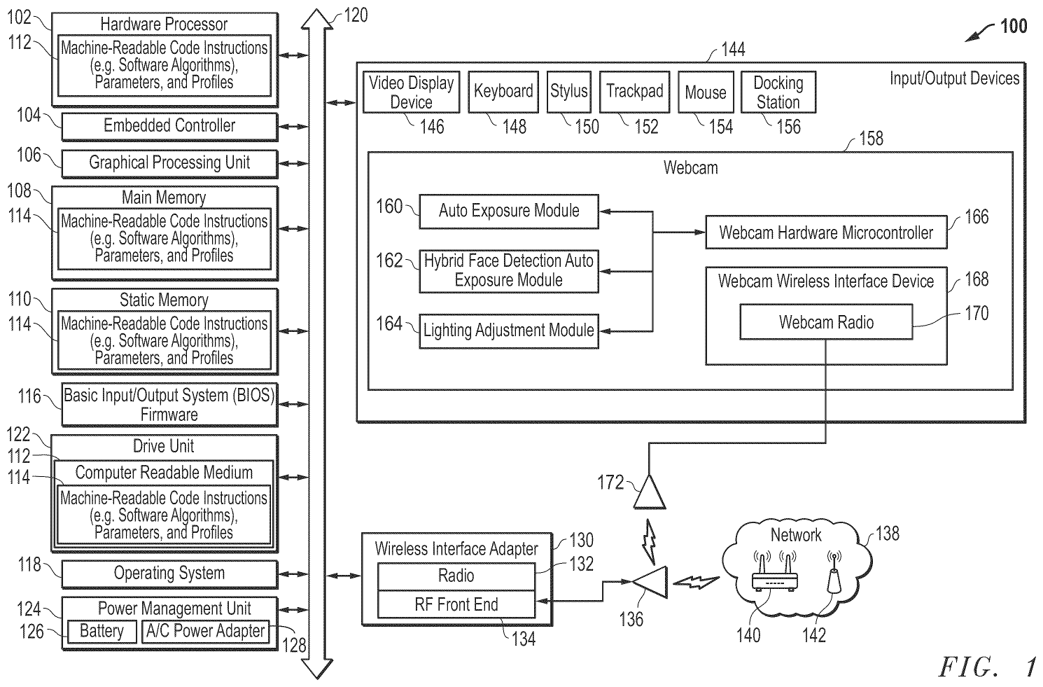

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 138, a base station transceiver 140, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality. It is appreciated that the information handling system 100 may be operatively coupled to any number of input/output devices 144 including a video display device 146, a keyboard, a stylus 150, a trackpad 152, a mouse 154, a docking station 156, and the webcam 158 described herein.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 108, (volatile (e.g., random-access memory, etc.), or static memory 110, nonvolatile (read-only memory, flash memory etc.) or any combination thereof), one or more hardware processing resources, such as a hardware processor 102 that may be a central processing unit (CPU), a graphics processing unit (GPU) 106, embedded controller (EC) 104, or any combination thereof. Additional components of the information handling system 100 may include one or more storage devices such as static memory 110 or drive unit 122. The information handling system 100 may include or interface with one or more communications ports for communicating with external devices, as well as various input and output (I/O) devices 144, such as a docking station 156, a mouse 154, a trackpad 152, a keyboard 148, a stylus 150, a video/graphics display device 146, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 114 that may operate on servers or systems, remote data centers, or on-box in individual client information handling systems according to various embodiments herein. In some embodiments, it is understood any or all portions of instructions (e.g., software algorithms), parameters, and profiles 114 may operate on a plurality of information handling systems 100.

The information handling system 100 may include the hardware processor 102 such as a central processing unit (CPU). Any of the processing resources may operate to execute code that is either firmware or software code. Moreover, the information handling system 100 may include memory such as main memory 108, static memory 110, and disk drive unit 122 (volatile (e.g., random-access memory, etc.), nonvolatile memory (read-only memory, flash memory etc.) or any combination thereof or other memory with computer readable medium 112 storing instructions (e.g., software algorithms), parameters, and profiles 114 executable by the EC 104, hardware processor 102, GPU 106, or any other hardware processing device. The information handling system 100 may also include one or more buses 120 operable to transmit communications between the various hardware components such as any combination of various I/O devices 144 as well as between hardware processors 102, an EC 104, the operating system (OS) 118, the basic input/output system (BIOS) 116, the wireless interface adapter 130, or a radio 132 module, among other components described herein. In an embodiment, the information handling system 100 may be in wired or wireless communication with the I/O devices 144 such as a docking station 156, a keyboard 148, a mouse 154, video display device 146, stylus 150, trackpad 152, or the webcam 158 described herein among other peripheral devices.

The information handling system 100 further includes a video/graphics display device 146. The video/graphics display device 146 in an embodiment may function as a liquid crystal display (LCD), an organic light emitting diode (OLED), a flat panel display, or a solid-state display. It is appreciated that the video/graphics display device 146 may be wired or wireless and may be an external video/graphics display device 146 that allows a user to increase the desktop area by extending the desktop in an embodiment. Additionally, as described herein, the information handling system 100 may include or be operatively coupled to one or more other I/O devices 144 including the wired or wireless mouse 154 that allows the user to interface with the information handling system 100 via the video/graphics display device 146, a cursor control device (e.g., a trackpad 152, or gesture or touch screen input), a stylus 150, and/or a keyboard 148, among others. Information handling system 100 may also be operatively coupled to a peripheral device 144 such as a docking station 156 or other smart peripheral device having a hardware processing device such as a hardware processor, microcontroller, or other hardware processing resource and which may further operatively couple to one or more additional peripheral devices 144. Various drivers and hardware control device electronics may be operatively coupled to operate the I/O devices 144 according to the embodiments described herein. The present specification contemplates that the I/O devices 144 may be wired or wireless.

A network interface device of the information handling system 100 shown as wireless interface adapter 130 can provide connectivity among devices such as with Bluetooth® or to a network 138, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the wireless peripheral devices via, for example, a Bluetooth® or Bluetooth® Low Energy (BLE) protocols. In an embodiment, the WAN, WWAN, LAN, and WLAN may each include an AP 140 or base station 142 used to operatively couple the information handling system 100 to a network 138. In a specific embodiment, the network 138 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna radio frequency (RF) front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 130 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes instructions, parameters, and profiles 114 or receives and executes instructions, parameters, and profiles 114 responsive to a propagated signal, so that a hardware device connected to a network 138 may communicate voice, video, or data over the network 138. Further, the instructions 114 may be transmitted or received over the network 138 via the network interface device or wireless interface adapter 130.

The information handling system 100 may include a set of instructions 114 that may be executed to cause the computer system to perform any one or more of the methods or computer-based functions disclosed herein. For example, instructions 114 may be executed by a hardware processor 102, GPU 106, EC 104 or any other hardware processing resource and may include software agents, or other aspects or components used to execute the methods and systems described herein. Various software modules comprising application instructions 114 may be coordinated by an OS 118, and/or via an application programming interface (API). An example OS 118 may include Windows®, Android®, and other OS types. Example APIs may include Win 32, Core Java API, or Android APIs.

In an embodiment, the information handling system 100 may include a disk drive unit 122. The disk drive unit 122 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 108 and static memory 110 may also contain a computer-readable medium for storage of one or more sets of machine-readable code instructions, parameters, or profiles 114 described herein. The disk drive unit 122 or static memory 110 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 108, the static memory 110, and/or within the disk drive 122 during execution by the hardware processor 102, EC 104, or GPU 106 of information handling system 100.

Main memory 108 or other memory of the embodiments described herein may contain computer-readable medium (not shown), such as RAM in an example embodiment. An example of main memory 108 includes random access memory (RAM) such as static RAM (SRAM), dynamic RAM (DRAM), non-volatile RAM (NV-RAM), or the like, read only memory (ROM), another type of memory, or a combination thereof. Static memory 110 may contain computer-readable medium (not shown), such as NOR or NAND flash memory in some example embodiments. The applications and associated APIs, for example, may be stored in static memory 110 or on the disk drive unit 122 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 124 (a.k.a. a power supply unit (PSU)). The PMU 124 may include a hardware controller and executable machine-readable code instructions to manage the power provided to the components of the information handling system 100 such as the hardware processor 102 and other hardware components described herein. The PMU 124 may control power to one or more components including the one or more drive units 122, the hardware processor 102 (e.g., CPU), the EC 104, the GPU 106, a video/graphic display device 146, or other wired I/O devices 144 such as the mouse 154, the stylus 150, a keyboard 148, and a trackpad 152 and other components that may require power when a power button has been actuated by a user. In an embodiment, the PMU 124 may monitor power levels and be electrically coupled to the information handling system 100 to provide this power. The PMU 124 may be coupled to the bus 120 to provide or receive data or machine-readable code instructions. The PMU 124 may regulate power from a power source such as the battery 126 or AC power adapter 128. In an embodiment, the battery 126 may be charged via the AC power adapter 128 and provide power to the components of the information handling system 100, via wired connections as applicable, or when AC power from the AC power adapter 128 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 includes a webcam 158. The webcam 158 may be any device that captures still images and/or video of the user as the user sits in front of the webcam 158 and information handling system 100. In an embodiment, this webcam 158 may be a built-in webcam 158 that is usually formed into a bezel of the video display device 146 of the information handling system 100 such as that found with a laptop-type information handling system 100. In this embodiment, a hardware microcontroller 166, such as a digital signal processor or other hardware processing resource at the webcam 158 or a hardware processor 102, GPU 106, or EC 104 may be used to execute the machine-readable code instructions, parameters, and profiles in firmware or software of the auto exposure module 160, the hybrid face detection auto exposure module 162, and the lighting detection module 164 at the webcam 158 to control exposure settings as described in embodiments herein. In an alternative embodiment, the webcam 158 may be operatively coupled to the information handling system 100 via a wired or wireless connection such that the webcam 158 is external to the information handling system 100. In this example embodiment, the webcam 158 may include its own hardware processing device such as a hardware microcontroller 166 that is used the execute the computer-readable program code of the auto exposure module 160, the hybrid face detection auto exposure module 162, and the lighting detection module 164. In order to communicate wirelessly with the information handling system 100, the webcam 158 may include a webcam wireless interface device 168, a webcam radio 170, and a webcam antenna 172 that operates similarly to the wireless interface adapter 130, radio 132, RF front end 134, and wireless antenna 136 of the information handling system 100.

During operation of the webcam 158, the webcam 158 may capture video images of the user during, for example, a videoconferencing session. Although the webcam 158 may be used to capture still images webcam 158, for ease of description, the present specification will describe the webcam 158 as capturing video that is streaming to the hardware processor 102, for example, for transmission to another information handling system operatively coupled to the information handling system 100 in FIG. 1 via the network 138 in order to engage in this videoconferencing session.

As the webcam 158 captures this video, the lighting within the image may change. This change in lighting may be due to a light being turned on, changes in light passing into the room via a window, a user blocking light, among other occurrences in front of the webcam 158. According to execution of the auto exposure module 160 by a hardware processing device such as webcam hardware microcontroller 166, this change in lighting may accommodate for these changes with an autoexposure (AE) algorithm to adjust the exposure of the captured images. However, as described herein, the user may visually detect that the image is occasionally overexposed or underexposed due to the execution of the auto exposure module 160 alone causing an exposure setting adjustment in some instances that results in over compensated exposure adjustments of a user's face as too bright or as too dark, such as when an very bright or very dark background lighting occurs in the image.

To compensate for such an over compensation on a user's face, a face detection algorithm, such as with artificial intelligence determining a face region of interest in the image, may adjust the exposure of this face region of interest such that over exposure or under exposure of the user's face does not occur. However, when the face moves or changes of lighting occur for the face region of interest, such as the user introduces a darker object into the viewable range of interest for a face in the webcam image, such as putting a dark colored hat on the user's head or looking down such that a user's hair is viewed in the image, the brightness of the image may noticeably decrease or increase and then settle into a new brightness level at the user's face over time as a result of AE hunting that changes the brightness of the images and video at the webcam as the user changes position or alters the shading at the image region of interest for the user's face within the viewable range of the webcam 158. Thus, where a certain exposure setting is selected by the AE software/firmware and the face detection auto exposure system for the image region of interest for the users' face, such AE hunting may be sensitive to any minor changes at the user's face to shading or colors that may not otherwise warrant an exposure setting adjustment and the result may be annoying for a user. Thus, actions at the user's face such as putting on a dark or light hat or if the user changes head position, such as to look down temporarily, the artificial intelligence face detection hunting of the face detection auto exposure system may adjust exposure of the system since the hat or the top of a person's head may be darker than an image of their face. In some drastic examples, this change in brightness may, even temporarily, overexpose the image of the user's face and take time to readjust or not readjust from artificial intelligence face detection hunting. These issues often lead to user dissatisfaction and frustration especially during a videoconference session where face-to-face conversations enhance the conversation.

The execution of firmware or software code instructions for the systems and methods described herein, however, allows the webcam 158 to determine the exposure levels both at the user's face region of interest in the image as well as the exposure levels at the background region of interest. In an embodiment, the hardware microcontroller 166 (e.g., a hardware digital signal processor) of the webcam 158 may execute computer-readable program code of a hybrid face detection auto exposure module 162 to detect a user's face within an image captured by the webcam. This detection of the user's face also allows the webcam hardware microprocessor 166 to define with an artificial intelligence algorithm a first image region of interest of the image (e.g., each image within a stream of images of the video captured) that includes the user's face, as a face region of interest. Additionally, execution of the computer-readable program code of the hybrid face detection auto exposure module 162 allows the webcam hardware microprocessor 166 to also define a second image region of interest of the image that includes a background of the image as a background region of interest captured in the image by the webcam 158. In an embodiment, this second image region of interest of the image may include all other parts of the captured image by the webcam 158 apart from the first image region of interest of the image that includes the user's face. Still further, execution of the computer-readable program code of the hybrid face detection auto exposure module 162 may also cause the exposure levels within the first image region of interest of the image (e.g., the exposure levels at the user's face) to adjust to correct exposure levels initially for the user's face during an initial detection of the user's face via artificial intelligence process used to analyze the image and detect a location of the user's face. Thus, where the user's face is initially detected within the image captured by the webcam 158, the execution of the computer-readable program code of the hybrid face detection auto exposure module 162 by the webcam hardware microprocessor 166 (e.g., a hardware digital signal processor) initially sets the exposure level appropriate for the user's face if the face is over or under exposed from dramatic brightness differences due to AE adjustments over the whole image.

In an embodiment, the hardware processing device (e.g., a webcam hardware microprocessor 166) of the webcam 158 may also execute computer-readable program code of the lighting detection module 164. The execution of the computer-readable program code of the lighting detection module 164 detects, on a continuous basis, brightness levels of the user's face within the first image region of interest of the image and brightness levels in the second image region of interest of the image captured by the webcam 158. Again, because the lighting of the user's face and the lighting of the background may be different, this difference may cause the execution of the computer-readable program code of the auto exposure module 160 and the hybrid face detection auto exposure module 162 to engage in AE hunting when a change in shading or brightness at the first image region of interest of the user's face leads to large or unnecessary visible changes to the exposure levels within the first image region of interest of the user's face in the image captured by the webcam 158 when the lighting or brightness of the overall image has not actually changed above a threshold amount.

These changes in the lighting levels and, consequently, control of the exposure levels within the first image region of interest of the image and second image region of interest of the image are compensated or not via execution of the hybrid face detection auto exposure module 162 according to embodiments herein. In an embodiment, changes in the brightness levels within both of the first image region of interest of the image and the second image region of interest of the image causes the webcam hardware microprocessor 166 to execute the computer-readable program code of the hybrid face detection auto exposure module 162 and the auto exposure module 160 to adjust exposure settings such as the ISO sensitivity settings or other exposure settings such as a shutter aperture setting of the webcam to automatically adjust the exposure levels of the image captured by the webcam. In another embodiment, the exposure levels are not changed by the execution of the computer-readable program code of the auto exposure module 160 and the hybrid face detection auto exposure module 162 unless a change in brightness levels within the second image region of interest of the image and is detected above a threshold level of brightness change. When the brightness level of the image within the second image region of interest of the image is detected as not having changed more than a threshold level of brightness change, the hybrid face detection auto exposure module 162 may supersede the execution of the auto exposure module 160 and the hybrid face detection auto exposure module 162 and determine that the exposure settings should not be adjusted to compensate for a detected underexposure or overexposure of the image within the first image region of interest of the image or the second image region of interest of the image. This latter state may occur when a change in shading in the first image region of interest around a user's face changes due to an action by the user, such as a dark hat or looking down, that is not substantial brightness change to the face and does not warrant an exposure adjustment.

In an embodiment, the execution of the computer-readable program code of the hybrid face detection auto exposure module 162 by the webcam hardware microprocessor 166 may adjust for changes in the detected lighting when a brightness change threshold is detected within the second image region of interest of the image. The exposure setting changes may then apply by execution of auto exposure module 160 and the hybrid face detection auto exposure module 162 to both the first image region of interest and the second image region of interest of the image or images from the webcam 158. In an embodiment, the brightness change threshold may be set to include a change in brightness of an increase or decrease of 15% or more. In another embodiment, the brightness change threshold may be set to include a change in brightness increase or decrease of 5% or more. Thus, the webcam hardware microprocessor 166 may execute the computer-readable program code of the hybrid face detection auto exposure module 162 to set a brightness change threshold that, when exceeded within the second image region of interest, adjusts the exposure values of the webcam such as the ISO sensitivity settings of the webcam 158 to automatically adjust the exposure levels of both the first image region of interest and the second image region of interest of the image captured by the webcam 158. For example, a user's face may be detected within the image of the webcam 158 in a first image region of interest of the image but may change when, for example, the user picks up a hat and places the hat on the user's head or looks down exposing the user's hair instead of the user's face in the image. This action changes the exposure levels within the first image region of interest of the image, but would cause AF hunting of exposure levels for the first image region of interest of the image. Thus, where the brightness change threshold at the second image region of interest of the image has not changed by a degree sufficient to necessitate an auto-exposure (AE) adjustment to the image, the exposure settings such as the ISO sensitivity settings will remain as they are for the first image region of interest of the image and maintain the exposure levels at the user's face during the action. Still further, when the change in brightness levels changes within the first image region of interest of the image occurs, changes in the brightness levels within the second image region of interest of the image must also have occurred at or exceeding the brightness change threshold, in order for the hybrid face detection auto exposure module 162 to adjust the exposure settings such as the ISO sensitivity settings and correct the changes in the exposure levels within first image region of interest of the image captured by the webcam 158.

In an embodiment, execution of the computer-readable program code of the hybrid face detection auto exposure module 162 also causes the user's face to be tracked within the image captured by the webcam 158. As such, the execution of the computer-readable program code of the hybrid face detection auto exposure module 162 causes the hybrid face detection auto exposure module 162 to readjust the location of the first image region of interest of the image that includes the user's face as the user's face changes position. This allows the first image region of interest to be located within the any portion of the image while also being able to be adjusted based on movements of the user during, for example, a videoconferencing session.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

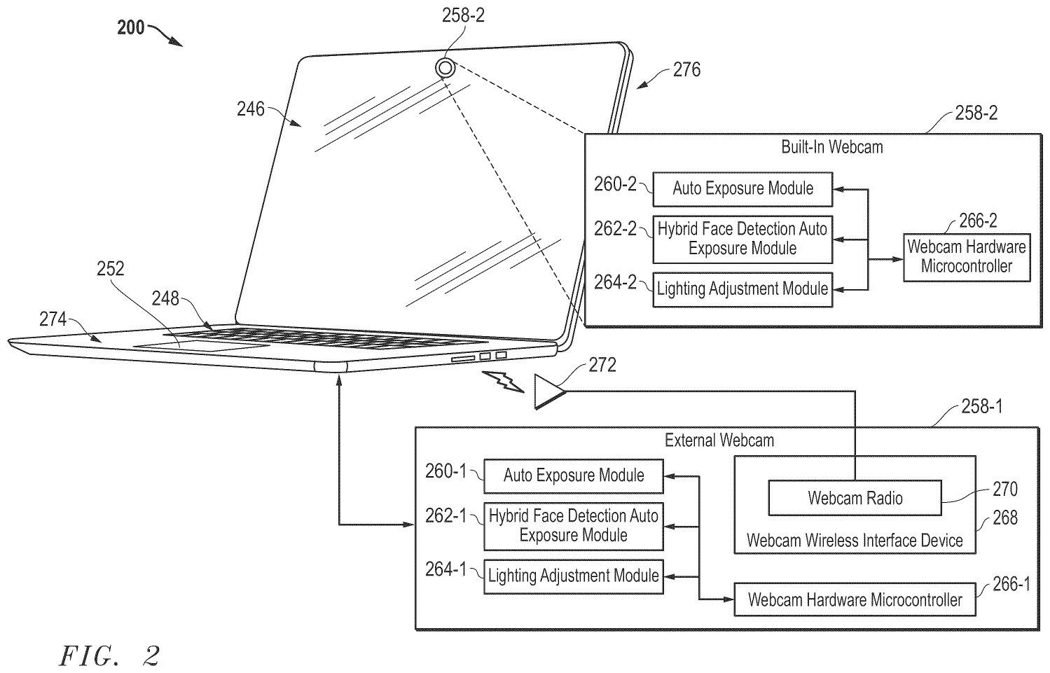

FIG. 2 is a block diagram illustrating an information handling system 200 including an external webcam 258-1 or a built-in webcam 25-2 according to another embodiment of the present disclosure. FIG. 2 shows a laptop-type information handling system 200. However, the present specification contemplates that other types of information handling systems 200 may be used in connection with the webcam 258. The laptop-type information handling system 200 may include a base chassis 274 operatively coupled to a display chassis 276 via, for example, a hinge system that allows the display chassis 276 to be rotated away from the base chassis 274. In an embodiment, the base chassis 274 may include a trackpad 252 and a keyboard 548 built into the base chassis 274. The display chassis 276 may also include a video display device 246 built into the display chassis 276. In an embodiment, the display chassis 276 may also include a built-in webcam 258-2 as described herein.

However, as described herein, the information handling system 200 may be operatively coupled to one or both of the built-in webcam 258-2 and an external webcam 258-1. The external webcam 258-1 may include similar elements as that of the built-in webcam 258-2 as well as additional elements used to, in this example embodiment, operatively couple wirelessly or by wired connection the external webcam 258-1 to the information handling system 200. In an example embodiment, the external webcam 258-1 may include a webcam wireless interface device 168, a webcam radio 170, and a webcam antenna 172 that operates to wirelessly couple the external webcam 258-1 to the information handling system 200. It is also appreciated that the external webcam 258-1 may be operatively coupled to the information handling system 200 via a wired connection (not shown) by, for example, a universal serial bus (USB) port formed in the base chassis 274 of the information handling system 200.

During operation of the webcam 258-1, 258-2, the webcam 258-1, 258-2 may capture video images of the user during, for example, a videoconferencing session. As the webcam 258-1, 258-2 captures this video, the lighting within the image may change. This change in lighting may be due to a light being turned on, changes in light passing into the room via a window, a user blocking light, among other occurrences in front of the webcam 258-1, 258-2. According to execution of the auto exposure module 260-1, 260-2 by a hardware processing device such as a webcam hardware microcontroller 266-1, 266-2 or a processor of information handling system 200, this changes in exposure settings may accommodate for these changes in lighting. However, as described herein, the user may visually detect that the image is occasionally overexposed or underexposed due to the execution of the auto exposure module 260-1, 260-2 alone resulting over-exposure or under-exposure of the face of a user due to changes the brightness of the images and video at the webcam in a background of the image that is dramatic or as the user changes position within the viewable range of the webcam 258-1, 258-2. For example, where a user appears in front of a bright window or a dark background, the execution of code instructions of the auto exposure module 260-1, 260-2 may adjust exposure over the whole image, but cause an under-exposure or an over-exposure of the user's face relative to this dramatically bright window or dark background.

In such drastic brightness difference examples in the images, this change in brightness may overexpose or under expose the user's face in the image. In some cases, the AE algorithm associated with the computer-readable program code of the auto exposure module 260-1, 260-2 used to control the exposure values of the images may apply a simple mean weightage algorithm and/or a central weightage algorithm that assumes that the user's face and body is generally always at a central location within the viewable range of the webcam 258-1, 258-2 but applies auto exposure to a mean or average adjustment over the whole image as weighted for the central region where the user out to be. Because users may not always present themselves directly within the middle of this viewable range or because the brightness difference from the background may be very dramatic, the execution of the AE algorithm of the auto exposure module 260-1, 260-2 may cause the user's face to over-exposed or under-exposed. The result may be where the background of the user is very dark, the user's face may be overexposed resulting in a whiteout effect of the user's face. The opposite is true where the user's face is often darkened by under-exposure when the background is highly illuminated by a light source such as a window. These issues often lead to user dissatisfaction and frustration especially during a videoconference session where face-to-face conversations enhance the conversation.

The execution of the systems and methods described herein, however, allows the webcam 258-1, 258-2 to consider the exposure levels at the user's face as well as the exposure levels at the background. First, the execution of code instructions for a hybrid face detection auto exposure module 260 may adjust for the over exposure or under exposure of the user's face by utilizing an artificial intelligence algorithm to detect the face in the image and apply a corrective exposure adjustment to the face region of interest when the above scenario arises. However, changes to the exposure level of the user's face region or movement of the user's face region within the images may cause the face detection auto exposure to conduct AF hunting while make adjustments to the exposure and searching for the face location. These exposure adjustments to the face region of interest may often be unnecessary exposure adjustments and may take time for the exposure levels of the face region of interest to adjust back or settle on the location of the user's face.

To address this, in an embodiment the hardware microcontroller of the webcam 258-1, 258-2 may execute computer-readable program code of a hybrid face detection auto exposure module 260 to detect a user's face within an image captured by the webcam 258-1, 258-2. This detection of the user's face also allows the hybrid face detection auto exposure module 262-1, 262-2 to define a first image region of interest of the image (e.g., each image within a stream of images of the video captured) that includes the user's face. Additionally, execution of the computer-readable program code of the hybrid face detection auto exposure module 262-1, 262-2 allows the hybrid face detection auto exposure module 262-1, 262-2 to define a second image region of interest of the image that includes a background of the image captured by the webcam 258-1, 258-2. In an embodiment, this second image region of interest of the image may include all other parts of the captured image by the webcam 258-1, 258-2 apart from the first image region of interest of the image that includes the user's face. Still further, execution of the computer-readable program code of the hybrid face detection auto exposure module 262-1, 262-2 may also cause the exposure levels within the first image region of interest of the image (e.g., the exposure levels at the user's face) to adjust for the correct exposure levels for the user's face initially during this process as described above if correction for a very bright or very dark background is necessary. Thus, where the user's face is initially detected within the image captured by the webcam 258-1, 258-2, the execution of the computer-readable program code of the hybrid face detection auto exposure module 262-1, 262-2 by the webcam hardware microprocessor 266-1, 266-2 initially sets the exposure level for the first image region of interest of the image to an appropriate level for the user's face. Execution of code instructions for the auto exposure module 260-1, 260-2 may also adjust the exposure level of the second image region of interest of the image for the background based on brightness across the entire image including the background.

In an embodiment, to detect the brightness levels in the first image region of interest of the image and second first image region of interest of the image, the hardware processing device (e.g., a webcam hardware microprocessor 266-1, 266-2) of the webcam 258-1, 258-2 may execute computer-readable program code of the lighting detection module 264-1, 264-2. The execution of the computer-readable program code of the lighting detection module 264-1, 264-2 detects, on a continuous basis, brightness levels of the user's face within the first image region of interest of the image and brightness levels in the second image region of interest of the image captured by the webcam 258-1, 258-2. Again, because the lighting of the user's face and the lighting of the background may be different, this difference may cause the execution of the computer-readable program code of the auto exposure module 260-1, 260-2 to over-expose or under-expose the user's face leading to large visible changes to the exposure levels of the user's face in the image captured by the webcam 258-1, 258-2 that would be undesirable.

However, these changes in the lighting levels and, consequently, the exposure levels within the first image region of interest of the image and second image region of interest of the image are compensated via execution of the hybrid face detection auto exposure module 262-1, 262-2 re-adjusting exposure levels for the first image region of interest of the image for the face of the user. However, any temporary changes to the first image region of interest of the image such as adding a dark or light hat or the user looking down such that hair instead of the user's face is captured may change the brightness level at the first image region of interest of the image. The operation of the hybrid face detection auto exposure module 262-1, 262-1 will inadvertently adjust for this sudden change in brightness at the face or movement of the face causing an AE hunting for face location and the right exposure level at the user's face again. This may be distracting and undesirable.

Therefore, execution of code instructions for the hybrid face detection auto exposure module 262-1, 262-2 detects changes in the brightness levels within both of the first image region of interest of the image and the second image region of interest of the image. The execution by the webcam hardware microcontroller 266-1, 266-2 of the computer-readable program code of the hybrid face detection auto exposure module 262-1, 262-2 will adjust exposure settings such as the ISO sensitivity settings of the webcam to automatically adjust the exposure levels of the image captured by the webcam when a threshold level of brightness change is detected in the second image region of interest of the image. This is because the exposure levels are not changed by the execution of the computer-readable program code of the auto exposure module 260-1, 260-2 unless a change in brightness levels within second image region of interest of the image, as well as in the first image region of interest of the image, is detected. When the brightness level of the image within second image region of interest of the image is detected as changing above a threshold level of brightness change, the execution of the hybrid face detection auto exposure module 262-1, 262-2 may supersede the execution of the auto exposure module 260-1, 260-2 and itself and that the exposure settings such as the ISO sensitivity settings should not be adjusted to compensate for a detected underexposure or overexposure of the first image region of interest of the image captured by the webcam 258-1, 258-2. Accordingly, the exposure for the second image region of interest of the image will not be adjusted either since it did not change enough in brightness level.

In an embodiment, the execution of the computer-readable program code of the hybrid face detection auto exposure module 262-1, 262-2 by the webcam hardware microcontroller 266-1, 266-2 may adjust for changes in the detected lighting within the first image region of interest of the image when a brightness change threshold is detected for the second image region of interest of the image. In an embodiment, the brightness change threshold may be set to include a change in brightness of 15% or more. In another embodiment, the brightness change threshold may be set to include a change in brightness of 5% or more. Any brightness change threshold level may be applied in various embodiments herein. Thus, the webcam hardware microcontroller 266-1, 266-2 may execute the computer-readable program code of the hybrid face detection auto exposure module 262-1, 262-2 to set a brightness change threshold that, when exceeded within the second image region of interest, adjusts the exposure settings such as the ISO sensitivity settings of the webcam 258-1, 258-2 to automatically adjust the exposure levels of the image captured by the webcam 258-1, 258-2 in the first image region of interest and also adjustment may occur for the second image region of interest. In an example embodiment, a user's face may be detected within a first image region of interest the image of the webcam 258-1, 258-2 but brightness may change when, for example, the user picks up a hat and places the hat on the user's head or looks down exposing the user's hair instead of the user's face. This action will change brightness at the first image region of interest causing changes the exposure levels within the first image region of interest of the image without the limitation on automatically changing exposure settings for the user's face in the first image region of interest as described above. Thus, where the brightness change has not changed by a degree sufficient to exceed the brightness change threshold at the second image region of interest, such as to necessitate an auto-exposure (AE) adjustment for example, the exposure settings such as the ISO sensitivity settings will remain as they are for the first image region of interest. Still further, even if the change in brightness levels changes within the first image region of interest of the image, changes in the brightness levels within the second image region of interest of the image must also have occurred, at or exceeding the brightness change threshold, in order for the hybrid face detection auto exposure module 262-1, 262-2 to adjust the exposure settings such as the ISO sensitivity settings and correct the changes in the exposure levels within the first image region of interest for the image captured by the webcam 258-1, 258-2. Similarly, the second image region of interest will not have been corrected for exposure levels since the detected brightness level at the second image region of interest did not change substantially.

In an embodiment, execution of the computer-readable program code of the hybrid face detection auto exposure module 262-1, 262-2 also causes the user's face to be tracked within the image captured by the webcam 258-1, 258-2. As such, the execution of the computer-readable program code of the hybrid face detection auto exposure module 262-1, 262-2 causes the hybrid face detection auto exposure module 262-1, 262-2 to readjust the location of the first image region of interest of the image that includes the user's face as the user's face changes position. This allows the first image region of interest to be located within the entire image while also being able to be adjusted based on movements of the user during, for example, a videoconferencing session.

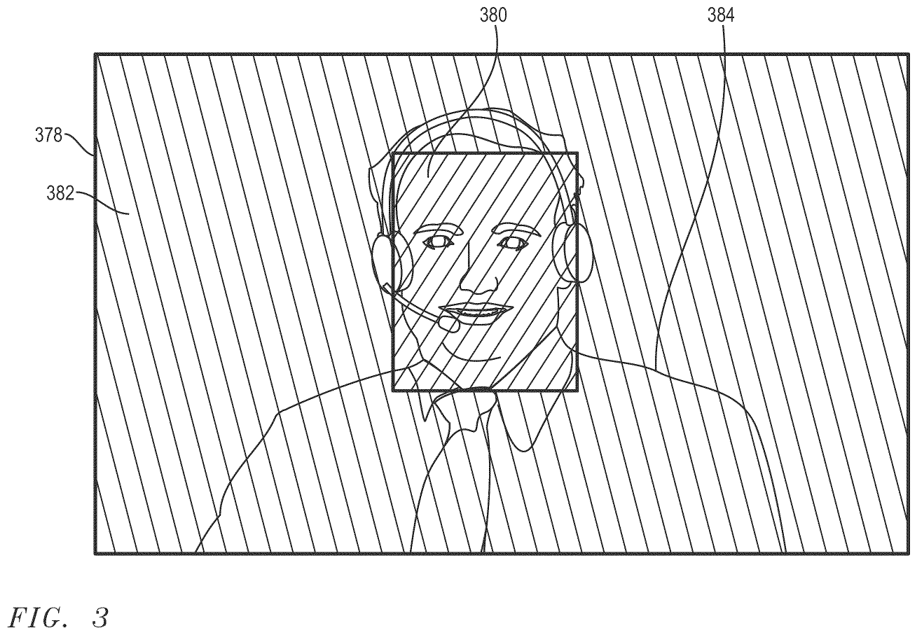

FIG. 3 is a graphic diagram of an image captured by a webcam including a first image region of interest 380 and a second image region of interest 382 as determined by execution of code instructions, including an artificial intelligence face detection algorithm, of a hybrid face detection auto exposure module and lighting detection module. Execution of code instructions for the hybrid face detection auto exposure module and the lighting detection module by a webcam hardware microcontroller may adjust the exposure of the captured image according to embodiments of the present disclosure. FIG. 3 shows a single frame or webcam image 378 captured of a user 384. Again, this image may be one of a plurality of images captured forming a streaming video captured by the webcam as described herein.

As described herein, the webcam hardware microcontroller may execute computer-readable program code of a hybrid face detection auto exposure module to detect a location of the user's 384 face and define the first image region of interest 380 within the webcam image 378. After defining this first image region of interest 380 around the user's 384 face, the hybrid face detection auto exposure module may define the remaining portions of the webcam image 378 as the second image region of interest 382.

In an embodiment, execution of the computer-readable program code of the hybrid face detection auto exposure module also causes the user's face to be tracked within the webcam image 378 captured by the webcam. As such, the execution of the computer-readable program code of the hybrid face detection auto exposure module causes the hybrid face detection auto exposure module to readjust the location of the first image region of interest of the webcam image 378 that includes the user's face as the user's face changes position. This allows the first image region of interest 380 to be located within the entire webcam image 378 while also being able to be adjusted based on movements of the user during, for example, a videoconferencing session.

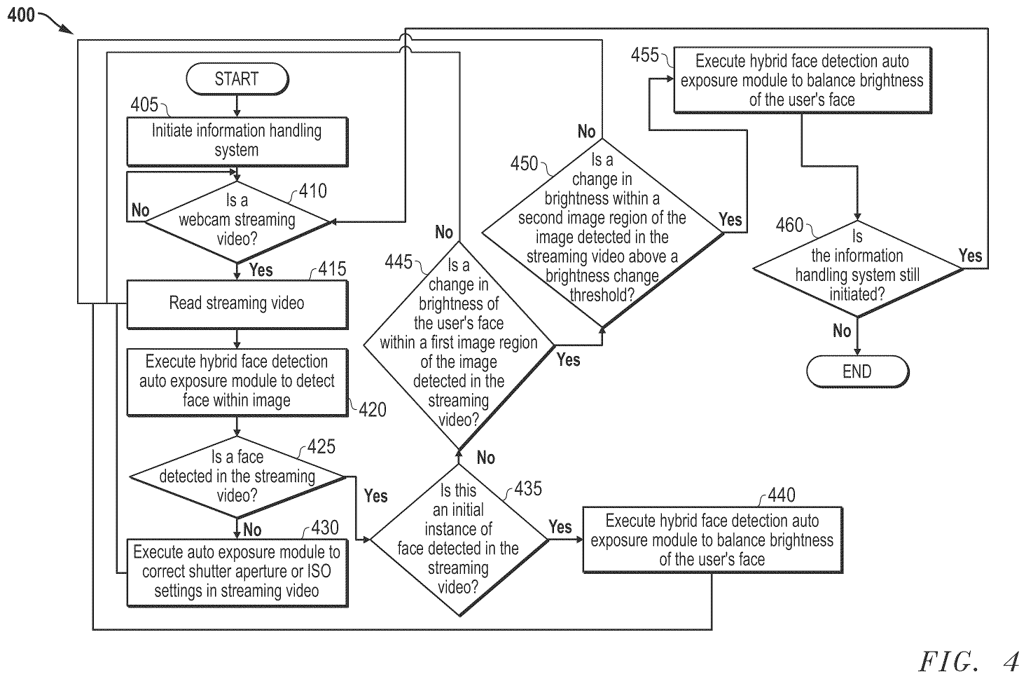

FIG. 4 is a flow chart showing a method 400 of correcting exposure of an image captured by a webcam according to an embodiment of the present disclosure. As described herein, the processes described in the flowchart may be executed by hardware processing resources at a built-in webcam at the information handling system or an external webcam operatively coupled to the information handling system.

The method 400 may include, at block 405, initiating the information handling system. This initiation process may include a user actuating a power button that causes a BIOS and OS of the information handling system to be executed in a boot-up process. In an embodiment, the information handling system may also execute computer-readable program code that discovers peripheral devices such as the webcam and executes drivers associated with the webcam so that the information handling system may send and receive data to and from the webcam.

At block 410, the information handling system may execute computer-readable program code of a driver associated with the webcam in order to determine if the webcam is streaming video. Where no video is streaming on the webcam, the information handling system may continue to monitor for this event. Where the information handling system has detected that video is streaming, the hardware processing device of the information handling system may read the streaming video at block 415 received from the webcam.

In an embodiment, the hardware processing device, such as a webcam hardware microcontroller of the webcam operatively coupled to the information handling system executes firmware or software code instructions of a hybrid face detection auto exposure module at block 420 to detect the user's face within the captured webcam images. In an embodiment, execution of the computer-readable program code of the hybrid face detection auto exposure module also causes the user's face, when detected, to be tracked within the webcam image captured by the webcam. As such, the execution of the computer-readable program code in firmware or software of the hybrid face detection auto exposure module causes the hybrid face detection auto exposure module to readjust a location of the first image region of interest of the webcam image that includes the user's face as the user's face changes position. This allows the first image region of interest to be located within the entire webcam image while also being able to be adjusted based on movements of the user during, for example, a videoconferencing session. In an embodiment, the execution of the hybrid face detection auto exposure module by the webcam hardware microcontroller identifies the detected face of a user as a first image region of interest in images captured by the webcam. In another embodiment, execution of the hybrid face detection auto exposure module by the webcam hardware microcontroller identifies a second image region of interest that, in an embodiment, includes those areas within the webcam images that are not included within the first image region of interest, or in other words the background region of interest.

At block 425, the webcam hardware microcontroller may determine if the user's face has been detected within the webcam image. Again, the execution of the hybrid face detection auto exposure module by the webcam hardware microcontroller may detect whether the user's face is present within the webcam image using, for example, a facial detection algorithm. Where, at block 425, no face is recognized in webcam image, the method 400 continues to block 430. Where a face is recognized, the method 400 continues to block 435. At block 430, the webcam hardware microcontroller may execute computer-readable program code of the auto exposure module to correct the exposure settings such as the shutter aperture settings and ISO sensitivity settings within the streaming video to automatically correct, if necessary, the exposure levels within the image as a whole. Determination of brightness and exposure levels of the user's face are not pertinent if no face is detected in the images captured by the webcam.

Returning to block 425, where a face is detected within the streaming video, the method 400 moves to block 435 with the determination of whether the facial recognition is an initial instance of the detected face in the streaming video. Again, if this is an initial instance of the face being detected within the streaming video, the method 400 moves onto block 440 for the webcam hardware microcontroller to balance the brightness of the user's face relative to the background exposure using the face detection auto exposure for adjustment of the detected first image region of interest for the user's face. Again, this detection of the user's face also allows the hybrid face detection auto exposure module to define a first image region of interest of the image (e.g., each image within a stream of images of the video captured) that includes the user's face. Application of auto exposure adjustments just to the user's face may correct an issue with extreme brightness differences between the background and the user's face, but may generate unnecessary exposure adjustments to the user's face when simple actions change the brightness of the user's face temporarily or not due to brightness levels in the background or in the room or location.

Additionally, execution of the computer-readable program code of the hybrid face detection auto exposure module allows the hybrid face detection auto exposure module to define a second image region of interest of the image that includes a background of the image captured by the webcam. In an embodiment, this second image region of interest of the image may include all other parts of the captured image by the webcam apart from the first image region of interest of the image that includes the user's face. Still further, execution of the computer-readable program code of the hybrid face detection auto exposure module may also cause the exposure levels within the first image region of interest of the image (e.g., the exposure levels at the user's face) to adjust for the correct exposure levels initially during this process at block 440. Thus, where the user's face is initially detected within the image captured by the webcam, the execution of the computer-readable program code of the hybrid face detection auto exposure module by the webcam hardware microprocessor 166 initially sets the exposure level appropriate for the user's face to correct for very bright or very dark backgrounds relative to the user's face and correct for over-exposure or under-exposure due to autoexposure adjustments across the image. At this point, the method 400 returns to block 415 with the information handling system continuing to read the streaming video and the webcam hardware microcontroller monitoring for the user's face and changes in brightness across the image.

However, where the detection of the user's face within the webcam image is not the initial instance of the facial detection at block 435, the method 400 proceeds to block 445 with the webcam hardware microcontroller determining if there is a change in brightness of the user's face within a first image region of interest of the image detected in the streaming video. Where no change in brightness (either higher or lower brightness) has been detected within the first image region of interest of the webcam image, the method 400 returns to block 415 with the information handling system continuing to read the streaming video and the webcam hardware microcontroller monitoring for the user's face and changes in brightness across the image as described herein.

However, where a change in brightness (either higher or lower brightness) has been detected within the first image region of interest of the webcam image, the method 400 continues to block 450 to also determine if a change in brightness has also been detected by the webcam hardware microcontroller within the second image region of interest of the webcam image that meets or exceeds the brightness change threshold in an embodiment. In particular embodiments, the brightness change threshold for brightness change, either brighter or darker, should exceed a change of 15% or more, 5% or more, or another brightness change threshold. Again, where change in brightness (either higher or lower brightness) has not been detected within the second image region of interest of the webcam image to exceed the brightness change threshold, the method 400 returns to block 415 as described herein. However, where the brightness level has changed within the second image region of interest at block 450, the method 400 continues to block 455.

It is appreciated that execution of the computer-readable program code of the hybrid face detection auto exposure module by the webcam hardware microprocessor, or in the case of the built-in webcam the hardware processor or other hardware processing resource in the information handling system in some embodiments, may adjust for changes in the detected lighting within the first image region of interest of the image and the second image region of interest of the image only when a brightness change threshold being met or exceeded is detected within the second image region of interest of the image captured by the webcam. In one embodiment, the brightness change threshold may be set to include a change in brightness of 15% or more. In another embodiment, the brightness change threshold may be set to include a change in brightness of 5% or more. Any brightness change threshold may be used including a brightness change threshold that would trigger an adjustment to the overall exposure of the image from execution of code instructions of the autoexposure module using, for example, the mean weightage across the image. Thus, the webcam hardware microprocessor may execute the computer-readable program code of the hybrid face detection auto exposure module to set a brightness change threshold that, when exceeded within the second image region of interest, adjusts the exposure settings such as the ISO sensitivity settings of the webcam to automatically adjust the exposure levels of the first image region of interest in image captured by the webcam at block 455 as described herein. The second image region of interest may also be automatically adjusted for exposure levels since its brightness has also been detected to have changed beyond a brightness change threshold amount. Thus, for example, a user's face may be detected within the image of the webcam but exposure levels may not change for the first image region of interest when, for example, the user picks up a hat and places the hat on the user's head which does not cause the second image region of interest brightness level to change more than the brightness change threshold amount. This action would otherwise change the exposure levels within the first image region of interest of the image causing AE hunting and unexpected and unwarranted exposure adjustments to the user's face. Thus, where the brightness change at the second image region of interest has not changed by a brightness change threshold amount, such as to a degree sufficient to necessitate an AE adjustment to the second image region of interest, the exposure settings such as the ISO sensitivity settings will remain as they are. However, where the brightness change at the second image region of interest has changed by a brightness change threshold amount, such as to a degree sufficient to necessitate an AE adjustment to the second image region of interest, the exposure settings such as the ISO sensitivity settings will be adjusted for the first image region of interest to adjust the exposure levels for the user's face as the second image region of interest may have exposure settings adjusted. Thus, even if the change in brightness levels changes within the first image region of interest of the image, changes in the brightness levels within the second image region of interest of the image must also have occurred at or exceeding the brightness change threshold, in order for the hybrid face detection auto exposure module to adjust the exposure settings such as the ISO sensitivity settings and correct the changes in the exposure levels at the first image region of interest within the image captured by the webcam.

Therefore, at block 455, the hardware processing device of the information handling system or webcam executes computer-readable program code of the hybrid face detection auto exposure module to balance the brightness of the user's face. Again, this allows the webcam to appropriately adjust the exposure levels within the first image region of interest and second image region of interest of the images captured by the webcam regardless of the detected location of the user's face.

At block 460, the method 400 may include determining whether the information handling system is still initiated. Where the information handling system is still initiated, the method 400 continues to block 410 as described herein. Where the information handling system is no longer initiated at block 460, the method 400 ends here.

The blocks of the flow diagram of FIG. 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A webcam, comprising:
a hardware microcontroller and a memory device;
the hardware microcontroller to execute computer-readable program code of a hybrid face detection auto exposure module to detect a user's face within an image captured by the webcam and define a first image region of interest of the image that includes the user's face and a second image region of interest of the image that includes a background of the image captured by the webcam;
the hardware microcontroller to execute computer-readable program code of a lighting detection module to detect brightness levels of the user's face within the first image region of interest of the image and brightness levels in the second image region of interest of the image captured by the webcam; and
the hardware microcontroller to execute computer-readable program code of a hybrid face detection auto exposure module to determine if a background brightness change threshold level is exceeded and to automatically adjust an exposure setting for the first image region of interest of the image captured by the webcam when the background brightness change threshold level is exceeded.

2. The webcam of claim 1 further comprising:
the hardware microcontroller to execute the computer-readable program code of the hybrid face detection auto exposure module to determine when the background brightness change threshold level is not exceeded and to prevent automatic adjustment to the exposure setting for the first image region of interest of the image captured by the webcam when the background brightness change threshold level is not exceeded.

3. The webcam of claim 2, wherein the background brightness change threshold level is set as a change in brightness of 15% at the second image region of interest.

4. The webcam of claim 1, wherein where no face is detected within the first image region of interest of the image the hardware microcontroller executes computer-readable program code of an auto exposure module to automatically adjust the exposure settings of the webcam across a whole portion of the image captured by the webcam.

5. The webcam of claim 1, wherein the background brightness change threshold level is set as a change in brightness of 5% at the second image region of interest.

6. The webcam of claim 1, wherein where the brightness level within the first image region of interest of the image changes but the brightness level within the second image region of interest of the image does not change by greater than the background brightness change threshold level, the hardware microcontroller executes the computer-readable program code of the hybrid face detection auto exposure module to maintain the exposure setting, including the ISO sensitivity setting of the webcam.

7. The webcam of claim 1 further comprising:
the hardware microcontroller to execute computer-readable program code of the hybrid face detection auto exposure module to track the user's face and readjust the location of the first image region of interest of the image that includes the user's face as the user's face changes position.

8. A method of correcting exposure of an image captured by a webcam comprising:
executing computer-readable program code of a hybrid face detection auto exposure module, via a webcam hardware microcontroller, to detect a user's face within an image captured by the webcam and define a first image region of interest of the image that includes the user's face and a second image region of interest of the image that includes a background of the image captured by the webcam; and
executing computer-readable program code of a lighting detection module, via the webcam hardware microcontroller, to detect brightness levels of the user's face within the first image region of interest of the image and brightness levels in the second image region of interest of the image captured by the webcam;
executing the computer-readable program code of the hybrid face detection auto exposure module to determine if a background brightness change threshold level is exceeded and to automatically adjust an exposure setting for the first image region of interest of the image captured by the webcam when the background brightness change threshold level is exceeded at the second image region of interest.

9. The method of claim 8, further comprising:
executing the computer-readable program code of the hybrid face detection auto exposure module to determine when the brightness change threshold level is not exceeded at the second image region of interest and to prevent automatic adjustment to the exposure setting for the first image region of interest of the image captured by the webcam when the brightness change threshold level is not exceeded at the second image region of interest.

10. The method of claim 8, wherein where no face is detected within the first image region of interest of the image the hardware microcontroller executes computer-readable program code of an auto exposure module to automatically adjust the exposure settings of the webcam across a whole portion of the image captured by the webcam.

11. The method of claim 10, wherein the brightness change threshold is a change in brightness of 15%.

12. The method of claim 8, wherein the background brightness change threshold level is set as a change in brightness of 5% at the second image region of interest.

13. The method of claim 8, wherein where the brightness level within the first image region of interest of the image changes but the brightness level within the second image region of interest of the image does not change, the hardware microcontroller executes the computer-readable program code of the hybrid face detection auto exposure module to maintain the ISO sensitivity settings of the webcam.

14. The method of claim 8 further comprising:
executing computer-readable program code of the hybrid face detection auto exposure module to track the user's face and readjust the location of the first image region of interest of the image that includes the user's face as the user's face changes position.

15. A webcam operatively coupled to an information handling system comprising:
a hardware processing device;
a memory device;
a power management unit (PMU) to provide power to the hardware processing device and the memory device; and
the webcam to capture an image of a user;
a webcam hardware microcontroller to execute computer-readable program code of a hybrid face detection auto exposure module to detect a user's face within an image captured by the webcam and define a first image region of interest of the image that includes the user's face and a second image region of interest of the image that includes a background of the image captured by the webcam;
the webcam hardware microcontroller to execute computer-readable program code of a lighting detection module to detect brightness levels of the user's face within the first image region of interest of the image and brightness levels in the second image region of interest of the image captured by the webcam;
the webcam hardware microcontroller to execute computer-readable program code of a hybrid face detection auto exposure module to determine if a background brightness change threshold level is exceeded by the brightness level at the second image region of interest and to automatically adjust an exposure setting for the first image region of interest of the image captured by the webcam when the background brightness change threshold level is exceeded at the second image region of interest; and
the webcam hardware microcontroller to execute the computer-readable program code of the hybrid face detection auto exposure module to determine when the background brightness change threshold level is not exceeded at the second image region of interest and to prevent automatic adjustment to the exposure setting for the first image region of interest of the image captured by the webcam when the background brightness change threshold level is not exceeded at the second image region of interest.

16. The information handling system of claim 15, wherein the background brightness change threshold level is set as a change in brightness of 15% at the second image region of interest.

17. The information handling system of claim 15, wherein where no face is detected within the first image region of interest of the image the hardware microcontroller executes computer-readable program code of an auto exposure module to automatically adjust the exposure settings of the webcam across a whole portion of the image captured by the webcam.

18. The information handling system of claim 15, wherein when the brightness level within the first image region of interest of the image changes but the brightness level within the second image region of interest of the image does not change by greater than the background brightness change threshold level, the hardware microcontroller executes the computer-readable program code of the hybrid face detection auto exposure module to maintain the exposure setting, including the ISO sensitivity setting of the webcam.

19. The information handling system of claim 15 further comprising:
the hardware microcontroller to execute computer-readable program code of the hybrid face detection auto exposure module to track the user's face and readjust the location of the first image region of interest of the image that includes the user's face as the user's face changes position.

20. The information handling system of claim 15, wherein the background brightness change threshold level is set as a change in brightness of 5% at the second image region of interest.
